(19) United States
(12) Patent Application Publication
(10) Pub. No.: US 2018/0280222 A1
(43) Pub. Date: Oct. 4, 2018

(54) ORTHOPEDIC POST PAD

(71) Applicant: Timothy Kelley Pichette, Nashville, TN (US)

(72) Inventor: Timothy Kelley Pichette, Nashville, TN (US)

(21) Appl. No.: 15/477,540

(22) Filed: Apr. 3, 2017

(51) Int. Cl. A61G 13/00; A61G 13/12; A61G 7/075

(52) U.S. Cl. CPC A61G 13/00; A61G 13/123; A47C 7/50; A61G 7/0755; A61G 7/075; A61G 13/12

(57) ABSTRACT

An orthopedic post pad comprising: an inner cushion layer, the inner cushion layer having a lune shape with a first peak, and a second peak; a post hole located in the inner cushion layer on a side opposite the two peaks; an outer cushion layer enveloping the inner lateral surface and concave surface of the inner cushion, the outer cushion layer and inner cushion layer together generally forming a right cylindrical shape.

### TECHNICAL FIELD

The invention relates to patient lower extremity positioning systems, and more particularly, to support components of patient lower extremity positioning systems.

### BACKGROUND

During Hip Arthroscopy and open procedures of the hip and femur, such as the acetabulum, femur, femoral neck and femoral head. A lower extremity distraction and positioning system is often used to distract the femoral head out of the acetabulum or is used to reduce the forces across a fracture site. These distraction and positioning systems are generally classified into two groups, including: fully functional tables with leg spars, and table attachment units that are attached to traditional operating room tables. Patients are generally placed in these systems in the supine or lateral decubitus position. Once in the distraction system, the patient's feet and legs are mounted into specialized boots or connection points and the patient's groin or perineal area rests against a counter traction post. In fracture cases the post may not be large but rather only about 2-3 inches wide. In hip arthroscopy it may be large). Once gross and fine traction are placed on the operative and nonoperative legs, the post may act as a fulcrum to stabilize the pelvis and allow the leg to be distracted without the patient slipping off the table platform. Once leg traction is achieved, the surgeon begins the procedure, which generally is in the anterior and lateral portion of the pelvis and hip joint. An orthopedic post pad may be used to prevent injury to the patient due to the forces exerted by the post on the patient. However, many known past pads do not provide the proper protection to patients, and patients may suffer from pudendal nerve palsy, neuralgia, and/or entrapment after the surgical procedure.

Thus there is a need for an orthopedic post pad that can overcome the above listed and other disadvantages.

### SUMMARY OF THE INVENTION

The invention relates to an orthopedic post pad comprising: an inner cushion layer, the inner cushion layer having a lune shape with a first peak, and a second peak; a post hole located in the inner cushion layer on a side opposite the two peaks; an outer cushion layer enveloping the inner lateral surface and concave surface of the inner cushion, the outer cushion layer and inner cushion layer together generally forming a right cylindrical shape.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a perspective view of the orthopedic post pad;

FIG. 2 is a top view of the orthopedic post pad;

FIG. 3 is a front view of the orthopedic post pad;

FIG. 4 is a side view of the orthopedic post pad;

FIG. 5 is a top perspective view of the orthopedic post pad;

FIG. 6 is a top perspective view of the orthopedic post pad with an orthopedic post located in the post hole;

FIG. 7 is a top view of a patient and an orthopedic post pad;

FIG. 8 is a top view of the orthopedic post pad pressed up against the perineum of the patient;

FIG. 9 is a top view of the orthopedic post pad when the patient is in traction;

FIG. 10 is a side perspective view of the orthopedic post pad and patient in a distraction and positioning system;

FIG. 11 is a more detailed side perspective view of the orthopedic post pad and patient in a distraction and positioning system;

FIG. 12 is a front perspective view of the orthopedic post pad and patient in a distraction and positioning system;

FIG. 13 is a view of the pad between the legs of a patient showing the ischial tuberosities and pudendal nerves of the patient;

FIG. 14 is a close-up view of FIG. 13;

FIG. 15 is a top view of the orthopedic post pad on a patient;

FIG. 16 is a top view of a prior art post pad on a patient;

FIG. 17 is a close-up view of the orthopedic pad on a patient with traction activated; and

FIG. 18 is a close-up view of the prior art post pad from FIG. 16, with traction activated.

### DETAILED DESCRIPTION

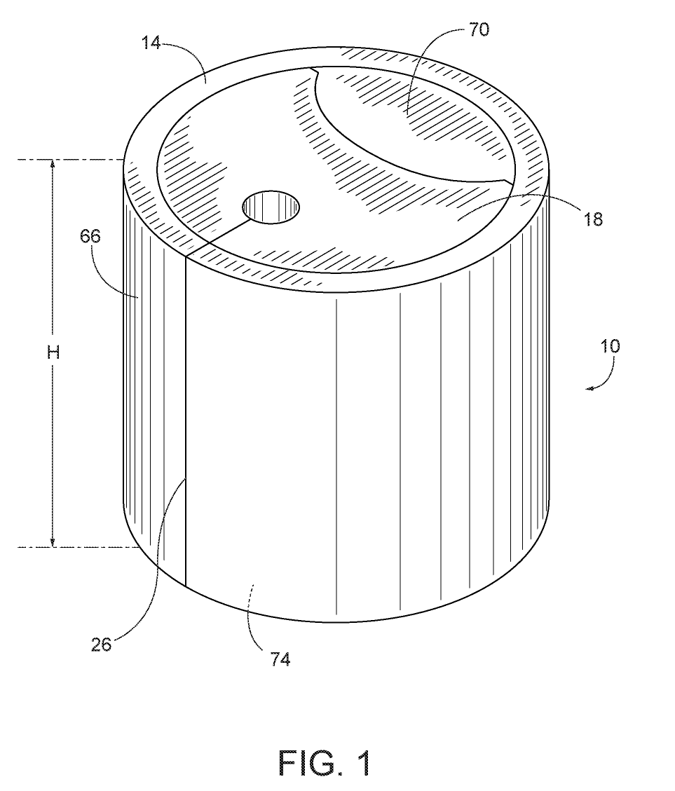

FIG. 1 shows a perspective view of the orthopedic post pad 10. In this view the outer cushion layer 14 is shown generally surrounding an inner cushion layer 18. Located in the inner cushion layer 18 is a post hole 22. The post hole is not located in the center of the post pad 10, but rather is located distal from the center of the post pad to provide more cushioning between the patient and the post. In one embodiment, the post hole center is located about 1.2″ away from the center of the post pad 10, in a direction along a line that is along the diameter of the pad 10. A slit 26 is located on the outer edge of the pad, and the slit may be a cut in the pad 10 from the outer edge of the pad 10 to the post hole 22. In one embodiment, the slit 26 may be glued shut, both in the inner cushion layer 18 and outer cushion layer 14. In this embodiment, the post may be slid up into the pad 10 from the bottom through the post hole 22. In another embodiment, the slit allows one to slide the pad onto an orthopedic post, until the post is generally within the post hole. 22. In another embodiment the slit 26 goes from the outer cushion layer 14 through the inner cushion layer 18 to the post hole 22. In another embodiment, the slit 26 only goes from the inner cushion layer 18 to the post hole 22, with the outer cushion layer 14 having no slit 26. The inner cushion layer 18 and outer cushion layer 18, together form a generally right cylindrical shape, with an outer lateral surface 66, a first base 70, a second base 74, and a height H.

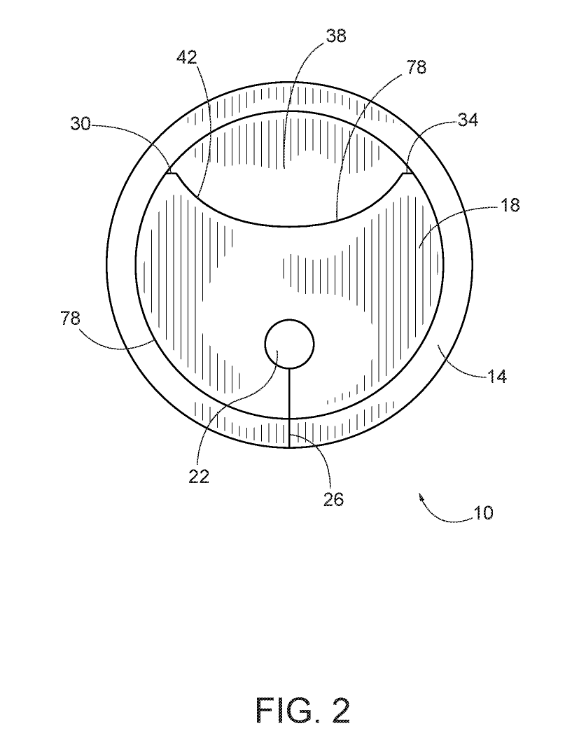

FIG. 2 shows a top view of the orthopedic post pad 10. In this view, the shapes of the outer cushion layer 14 and inner cushion layer 18 will be discussed. In the top view (and bottom view) of the orthopedic post pad 10, the inner cushion layer 18, may have a lune shape. In plane geometry, a lune is the concave-convex area bounded by two circular arcs, while a convex-convex area is termed a lens. The word “lune” derives from Luna, the Latin word for Moon. The lune shape of the inner cushion layer 14 comprises two peaks 30, 34. The outer cushion layer 14 forms an additional cushion volume 38 that generally fits into the concave portion 42 of the lune shape. The inner cushion layer 18, forms a partial right cylindrical shape with a concave surface 78, that extends down the height H of the cylinder shape. The concave surface 78 is generally the concave portion 42 extending along the height H of the cylinder. The partial right cylindrical shape of the inner cushion layer 18, has an inner lateral surface 82, and a concave surface 78, both of which extend along the height H of the right cylindrical shape. The diameter of the pad may be about 9″, the height H of the pad may be about 9″. The diameter of the post hole 22 may be about 1.25″. The distance between the two peaks 30, 34 may be about 5.75″. The distance between the two peaks may be based on the fact that the average distance between the inner portions of the two ischial tuberosities is about 4.5″. In other embodiments, rather than a lune shape, the inner cushion layer 18 may have two peaks 30, 34, with a portion of the cushion between the two peaks 30, 34, cut out of the inner cushion layer 18 along the height H of the inner cushion layer, such as to leave room for additional cushion volume 38 of the outer cushion layer 14. Also, the concave surface 78 need not be a smooth surface, but may comprise planar surfaces, or a plurality of curved surfaces.

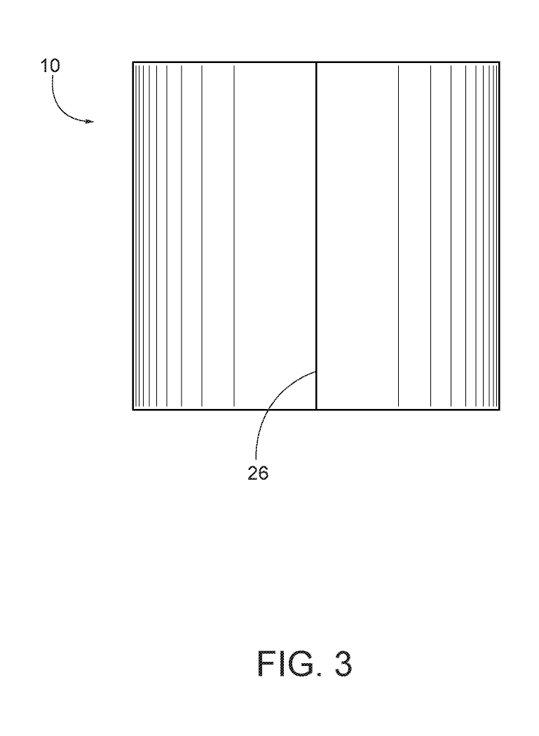

FIG. 3 shows a front view of the orthopedic post pad 10.

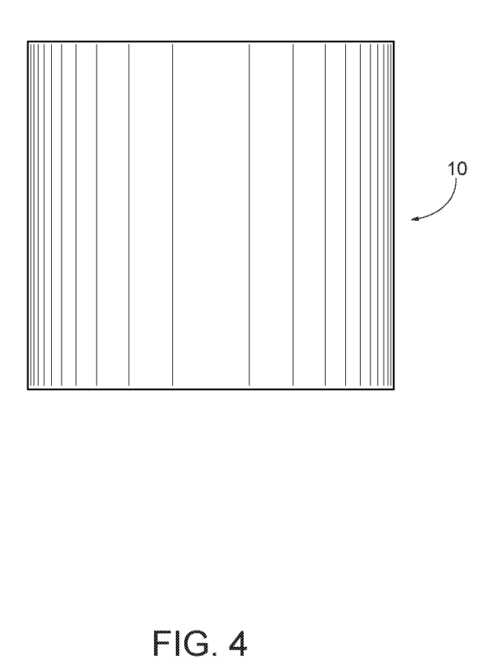

FIG. 4 shows a side view of the orthopedic post pad 10.

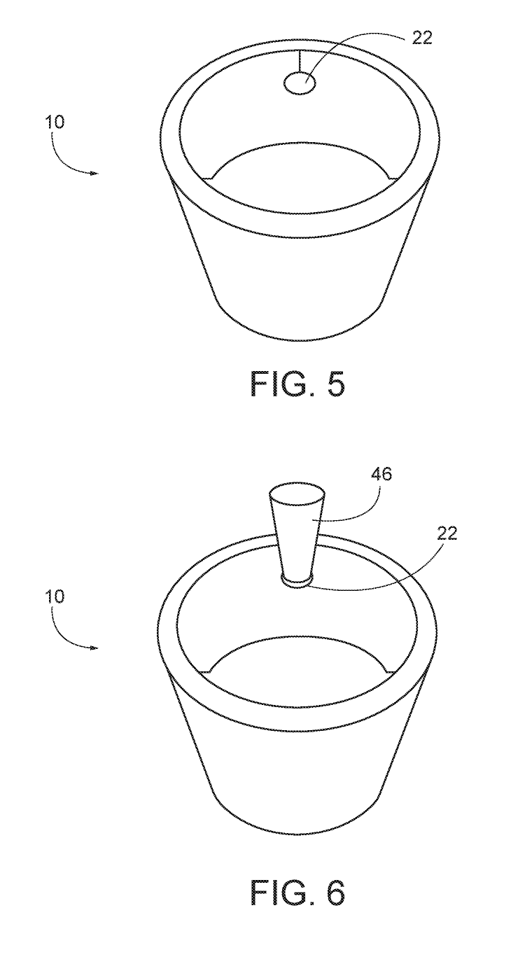

FIG. 5 is a top perspective view of the orthopedic post pad 10 without an orthopedic post. FIG. 6 is a top perspective view of the orthopedic post pad 10 with an orthopedic post 46 located in the post hole 22.

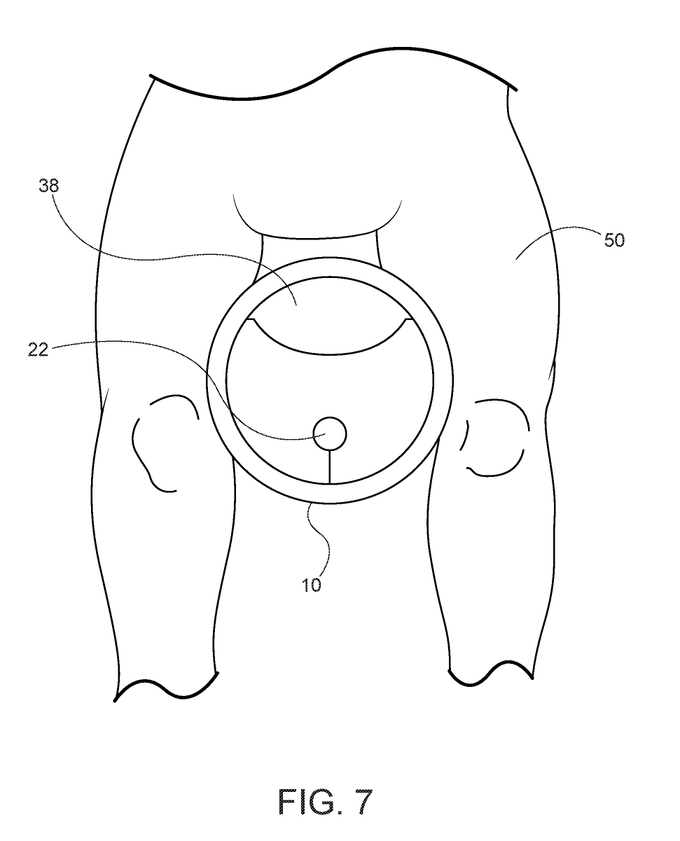

FIG. 7 shows a top view of the orthopedic post pad 10 located between the legs of a patient 50. The orientation of the pad 10 is such that the additional cushion volume 38 faces the genital area of the patient 50, and the post hole 22 is facing away from the patient's torso. FIG. 7 may show how the pad 10 is first positioned on a patient 50.

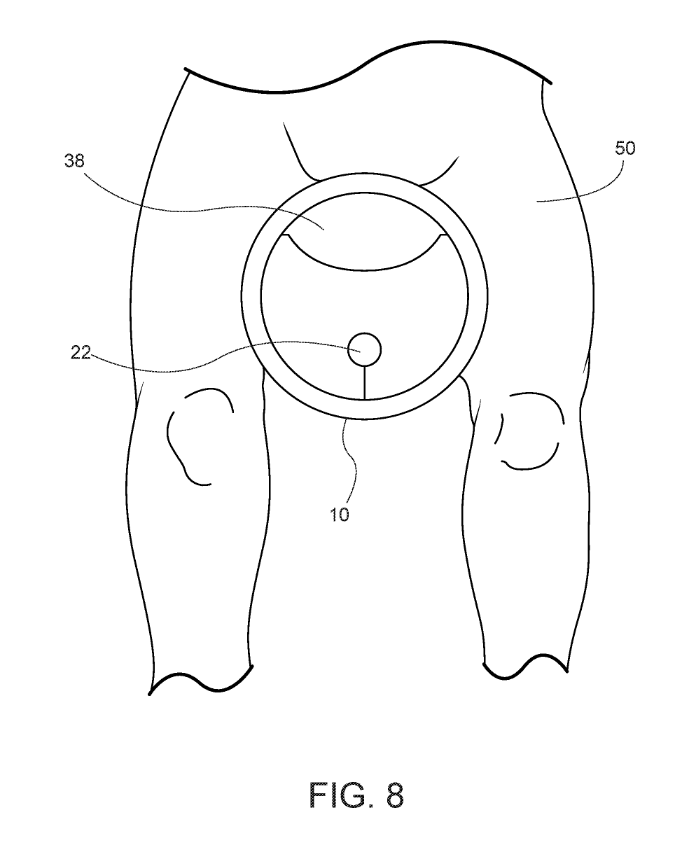

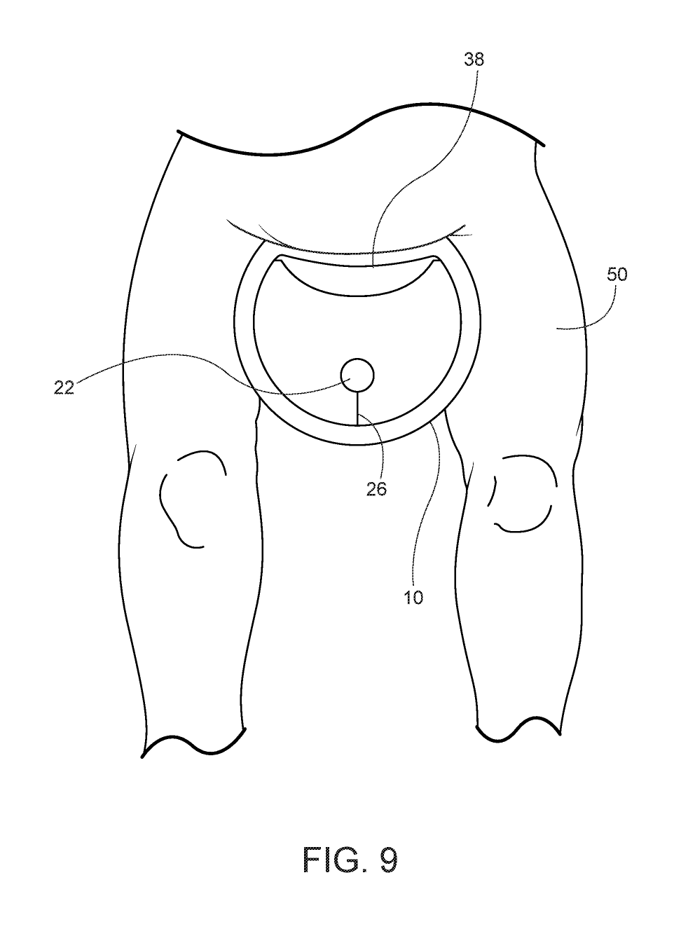

FIG. 8 shows the pad 10 generally abutting the perineum of the patient 50, and how the pad 10 would be positioned before traction is turned on. FIG. 9 shows the position of the pad 10 when traction is turned on. In this figure, the perineum is pressed up against the pad 10 such that the additional cushion volume 38 is compressed as shown.

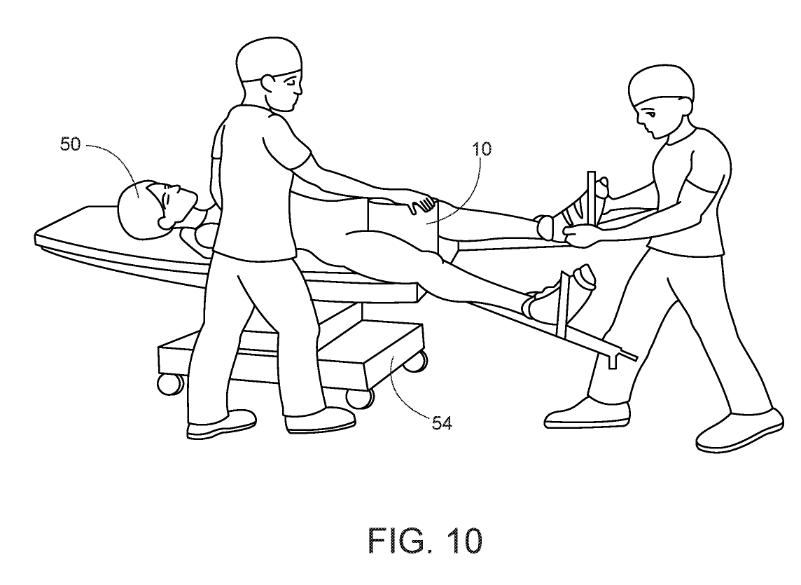

FIG. 10 shows the pad 10 inserted on an orthopedic post of a lower extremity distraction and positioning system 54 with a patient 50 in the lower extremity distraction and positioning system 54.

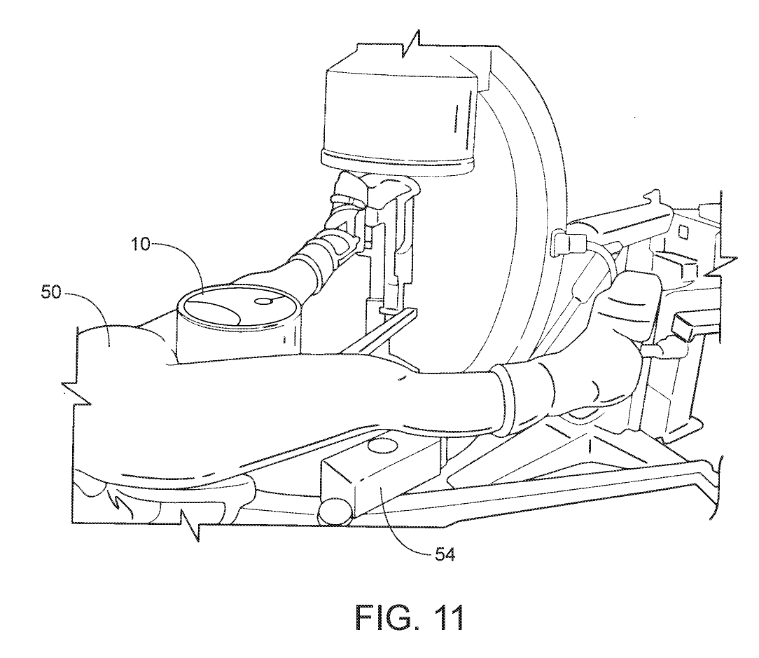

FIG. 11 is a side perspective view of a patient 50 in a lower extremity distraction and position system 54. The pad 10 is shown installed on an orthopedic post (not visible) and between the patient's legs, but generally before traction is applied.

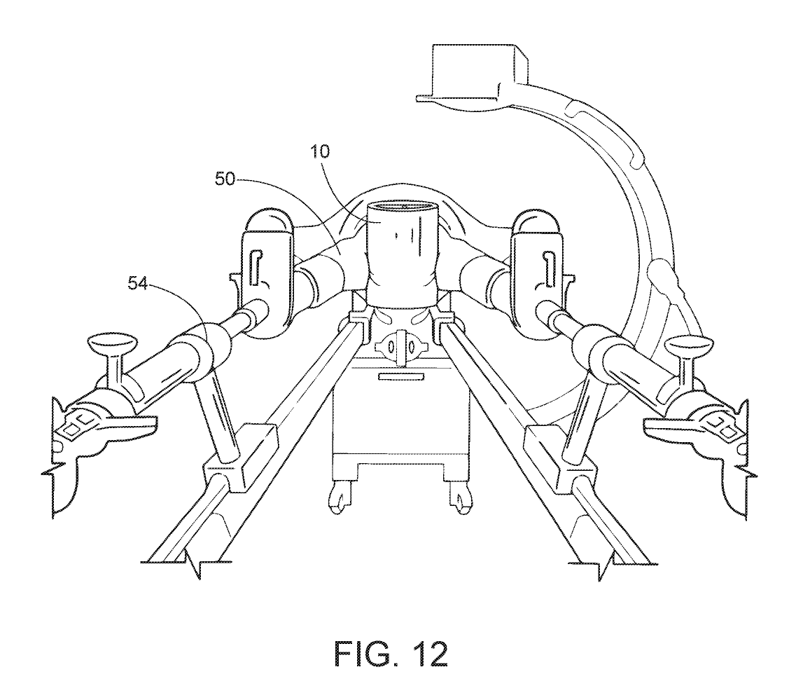

FIG. 12 is a front perspective view of the patient 50 in a lower extremity distraction and position system 54. The pad 10 is shown installed on an orthopedic post (not visible) and between the patient's legs, but generally before traction is applied.

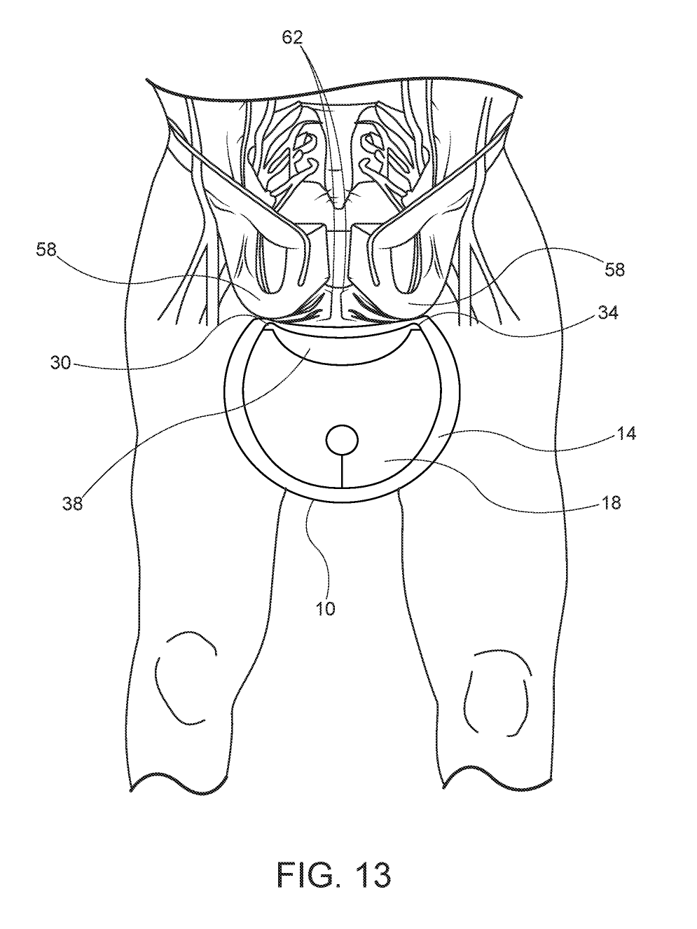

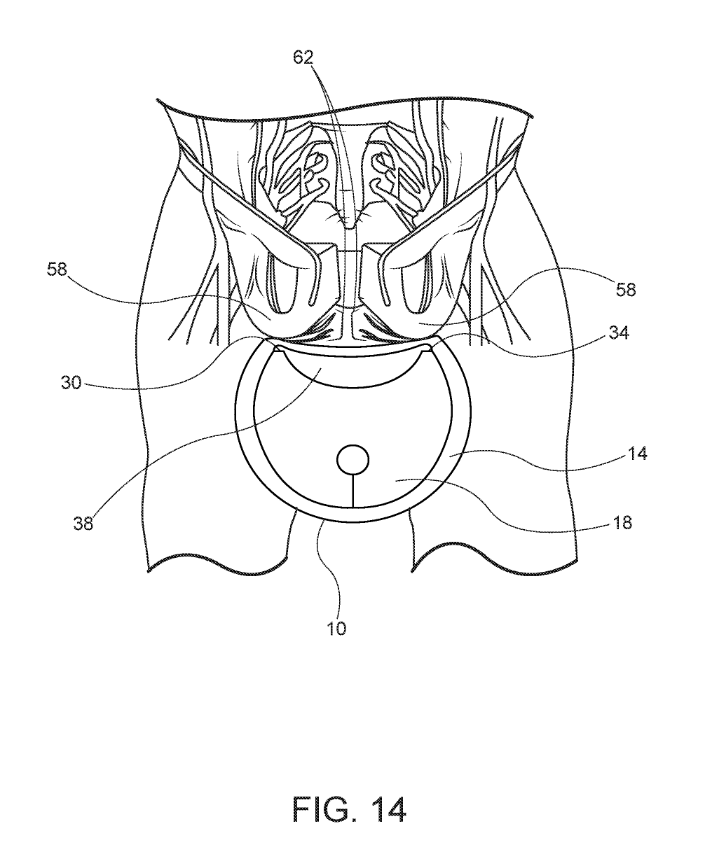

FIG. 13 is a view of the pad 10 between the legs of a patient 50, showing the ischial tuberosities 58 and pudendal nerves of the patient 50. FIG. 14 is a close-up view of the pad 10 and the ischial tuberosities 58 and pudendal nerves of the patient 50 from FIG. 13. The inner cushion layer 18 may be comprised of a cushioning material, such as but not limited to foam, that is resistant to over 100 pounds of pressure. The inner cushion layer 18 may be 18110 open celled polyurethane foam. 18110 open celled polyurethane foam may be obtained from G&T Industries 290 East 30^{th} Street Jasper, Ind. 47546. The inner cushion layer thus may be very rigid and firm. When looking at the inner cushion layer 18, one will see the concave portion 42 of the inner cushion layer 18 that faces the patient. The function of this concave portion 42 is to provide an additional cushion volume 38 in the outer layer 14. This additional cushion volume 38 will generally provide enough cushioning to avoid excessive pressure on the patient's pudendal nerve and its three branches, which are the dorsal, perineal, and rectal nerves. Pressure on the pudendal nerve and its branches can cause pudendal nerve palsy or neuralgia/entrapment. Pudendal nerve palsy is a very common complication of hip arthroscopy. A palsy occurs when these nerves are damaged due to heavy compression. The most common palsy occurs in the dorsal branch due to it being just distal of the hard surface of the Inferior Pubic Ramus (bone). When an external force traps and pressures the dorsal branch between itself and the inferior pubic ramus, a palsy, neuralgia, or entrapment can occur. Injury to patients during hip arthroscopy is well known. It has been reported that 74% of hip arthroscopy patients suffered some sort of traction-related problems after hip arthroscopy in, as described in “Traction-Related Problems After Hip Arthroscopy” by Lone Frandsenl, Bent Lund, Torsten Grønbech Nielsen, and Martin Lind; Journal of Hip Preservation Surgery 2017, pp. 1-6, incorporated herein by reference in its entirety. The incidence of pudendal nerve palsy following routine trauma and elective orthopaedic surgery procedures ranges from 1.9% to 27.6% as described in “Pudendal Nerve Palsy in Trauma and Elective Orthopaedic Surgery”, by Ioannis Polyzois, Konstantinos Tsitskaris, Sam Oussedik, Injury, Int. J. Care Injured 44 (2013), 1721-1724, incorporated herein by reference in its entirety. The potential complications associated with hip arthroscopy include broken intra-articular instruments, iatrogenic chondral damage, and nerve palsies, most commonly of the lateral femoral cutaneous and pudendal nerves, as described in “Hip Arthroscopy in Adults”, by Russell M. Nord, M.D., and Robert J. Meislin, M.D., Bulletin of the NYU Hospital for Joint Diseases 2010; 68(2):97-102, incorporated herein by reference in its entirety.

The peaks 30, 34 of the inner cushion layer 18 are configured to anchor on or outside of the ischial tuberosities 58. The average distance between the ischial tuberosities is about greater than 3.9″. Many studies show the average distance between ischial tuberosities to be about 4.5″. The distance between our peaks 30, 34 may be about 5.75″. Generally, one does not want to be on the inside ridge of the ischial tuberosity, which is at 4.5″, the peaks 30, 34 should be on or near a solid portion of the bone, therefore the peaks of the present invention may be at about 5.75″. One may ask why are the peaks 5.75″ apart when the ischial tuberosity are about 4.5″ apart? One does not want to anchor right on the inner edge of the ischial tuberosity, one wants to be towards the center or outer portion. Also, the pad is usually compressed a bit inward towards the center of the pad as the operative leg is positioned into the pad to provide an outward push on the hip joint.

A pediatric post pad may have a smaller distance between the peaks 30, 34, with peaks at about 4.5″ to about 5″ apart. The diameter of the pediatric post pad may be about 7″ to 7.5″. This is specifically done because there is no nerve to bone overlap in this area, and the denser inner cushion layer 18 avoids compressing on the pudendal nerves 62. The disclosed pad is the only pad known to have an internal support system that anchors at the ischial tuberosity and outward to avoid pudendal nerve palsy. Note that the support structure of the pad then arcs away from the patient and pudendal nerve area to provide less pressure and more relief on the nerve area. The additional cushion volume 38 is filled with ultra-soft foam for reasons described above.

The outer cushion layer 14 may be very soft and may be, but is not limited to, foam termed by the foam industry as “Ultra-Soft.” The outer layer cushion 14 may be 1119 open celled polyurethane foam. 1119 open celled polyurethane foam may be obtained from G&T Industries 290 East 30^{th} Street Jasper, Ind. 47546. The outer cushion layer 14 will be very easily compressed and acts as a cloud around the more rigid or firm inner cushion layer 18. The inner cushion layer 18 is very firm and provides the structural integrity needed by the pad for the procedure along with anchoring at specific anatomical locations on the patient. The outer cushion layer 14 serves to protect the patients skin as it is very soft to the touch which prevents any kind of a sheering injury to the skin. The outer cushion layer 14 also has an additional cushion volume 38 so that the male genitals do not descend between the pad and the patient's perineum during the hip arthroscopy procedure.

An example of using the orthopedic post pad, may comprise the following steps. To begin the surgical case, the male genitals are positioned proximal (towards the patients naval) to avoid entrapment with the pad once traction (pulling of the lower extremities downward towards the pad with about 100 pounds of pressure) is applied. The patient is then covered by surgical drapes and the genitals are no longer visible. Traction occurs intermittently throughout the procedure. It is primarily “on” during the procedure, which may last about 40-180 minutes, but there are times when traction is released or “off” to provide relief to the patient's nerves and anatomy. The additional cushion volume 38 is in place so the male genitals do not descend between the pad and the patient's perineum when the traction is turned “off” during the procedure. If the genital were to fall between the pad and the patient's perineum while traction is temporarily released or “off”, they would then be compressed once the traction is later applied or turned back “on” again during the procedure, which may cause extreme damage to the genitals.

It can be observed that the inner cushion layer 18 extends laterally, almost to the edge, of the pad. This was specifically done to provide a lateral traction force on the medial thigh. This lateral force from the pad, when used in conjunction with the surgical table which provides axial traction, distracts (creates a gap between the ball and socket of the joint) the hip which is necessary to access the joint with surgical instrumentation. Ideally, the vector of traction placed on the hip joint (lateral from the pad, axial from the table) is about equal to the about 125 degree anatomical angle of the femoral neck. This way one is pulling on the femoral head (ball of the ball and socket joint), from its natural anatomical support structure, which is the femoral neck. One is also now creating or producing a more uniform gap between the femoral head and the acetabulum (ball and socket) so that surgical instrumentation can access the entire surface areas of both femoral head and acetabulum.

The outer cushion layer acts as a barrier to prevent the male genitals do not fall between the patient and the pad. The outer cushion layer also provides a gentle surface for skin contact. The inner cushion layer provides the structural support of the pad and specifically anchors starting at the patient's ischial tuberosity and outward to avoid any pressure on the pudendal nerve, and the pudendal nerve's three branches, and the inferior pubic ramus that could cause a nerve entrapment. Furthermore, the inner cushion layer then arcs away from the pudendal nerve area to avoid and reduce pressure at the nerve site.

The pudendal nerve is the main nerve of the perineum. It carries sensation from the external genitalia of both sexes and the skin around the anus and perineum, as well the motor supply to various pelvic muscles, including the male or female external urethral sphincter and the external anal sphincter. If damaged, lesions may cause sensory loss or fecal incontinence. The pudendal nerve supplies sensation to the penis in males and the clitoris in females, through the branches dorsal nerve of penis and dorsal nerve of clitoris. The posterior scrotum in males and the labia in females are also supplied, via the posterior scrotal nerves (males) or posterior labial nerves (females). The pudendal nerve is one of several nerves supplying sensation to these areas. Branches also supply sensation to the anal canal. By providing sensation to the penis and the clitoris, the pudendal nerve is responsible for the afferent component of penile erection and clitoral erection. It is also responsible for ejaculation. Inside the pudendal canal, the nerve divides into branches, first giving off the inferior rectal nerve, then the perineal nerve, before continuing as the dorsal nerve of the penis (in males) or the dorsal nerve of the clitoris (in females).

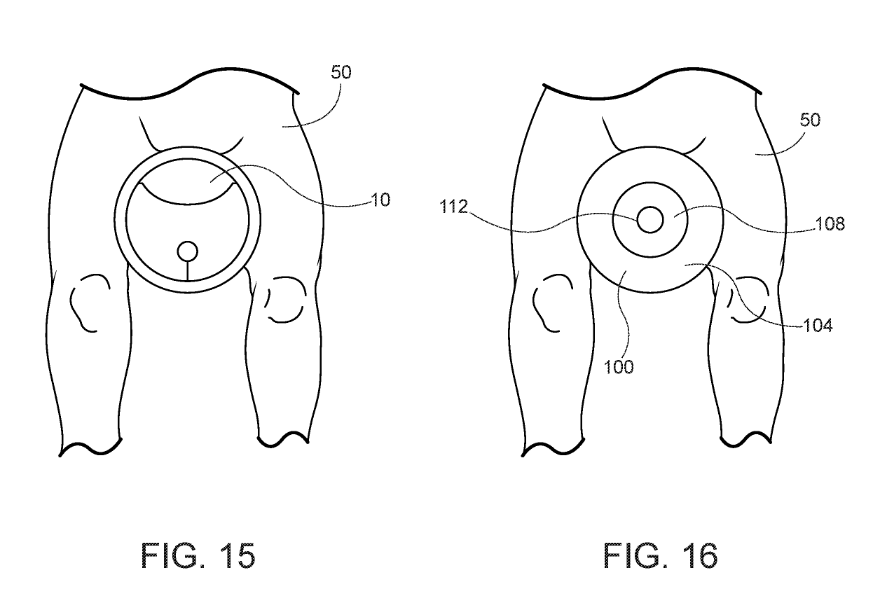

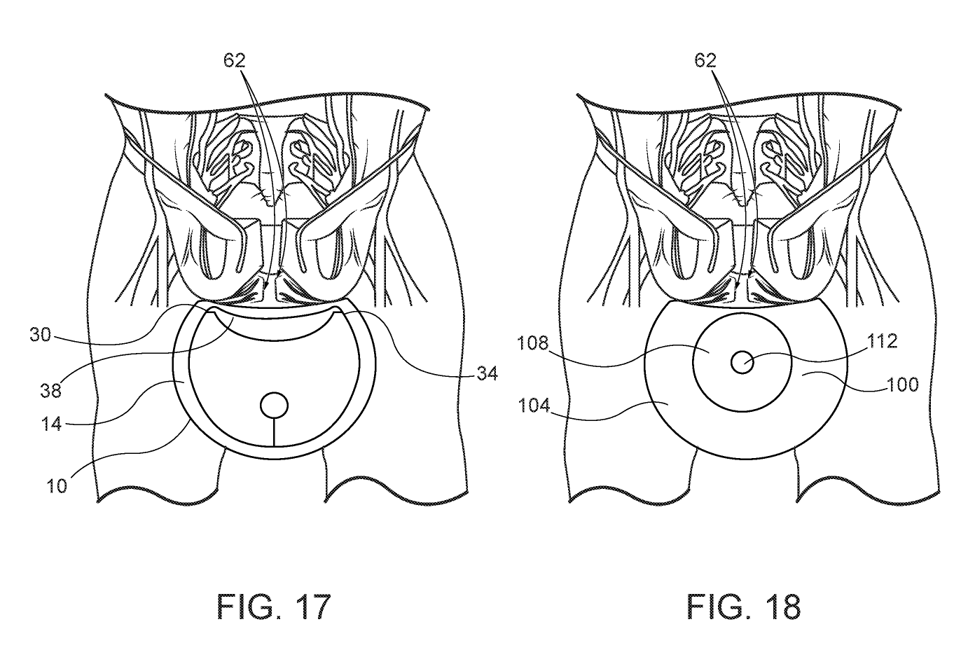

FIG. 15 shows the current orthopedic post pad 10 between the legs of a patient prior to traction being applied. FIG. 16 shows a prior art post pad 100 between the legs of a patient prior to traction being applied. The prior art post pad 100 may have a post hole 112 located generally in the center of the pad 100, and a soft outer cushion layer 104 and a harder inner cushion layer 108. The outer cushion layer 104 and inner cushion layer 108 are cylindrical in shape, without the lune shape of the instant invention. FIG. 17 is a close up view of the post pad 10 from FIG. 15, but with traction applied. In FIG. 17, cone can see that the outer cushion layer 14, which has the additional cushion volume 38 is providing soft cushioning to the area where the pudendal nerves 62 are located. The only location where the harder inner cushion layer 18 is close to abutting the patient 50 is at the peaks 30, 34. In the prior art post pad 100, it can be seen that the inner cushion layer 108, as the pad 100 is compressed, is nearly abutting the patient, and the harder inner cushion layer 108 may be causing damage to the pudendal nerves 62, and could cause damage to the skin of the patient, and genitals of the patient if the male genitals fall between the perineum and the pad 100. The arrows in FIGS. 17 and 18 represent pressure from the pad 10, 100 on the patient 50.

The inner cushion layer has two peaks which function to anchor on the ischial tuberosity. This two peak design avoids excessive force on the pudendal nerve and its three branches which overlap with bone and anatomical structures located internal to the ischial tuberosity. The inner cushion layer has a concave portion 42 that allows the outer cushion layer to have an additional cushion volume 38 that provides for a softer cushion adjacent to and abutting the patient's perineum. It should be noted that the shape of the inner cushion layer 18 is not limited to the lune shape, but may also include a hexagon shaped cut-out, an arc shape made of 2 or mare straight or curved lines, any shape that provides for two peaks in the inner cushion layer 18 and for an additional cushion volume 38 in the outer cushion layer 14. The additional cushion volume 38 functions to avoid applying supportive pressure on the pudendal nerve and its three branches which are the perineal branch, dorsal branch, and rectal branch. The outer cushion layer 14 has an additional cushion volume 38 which may function as a “stop-gap” or “plug” to prevent the male genitals from falling into the additional cushion volume 38.

This invention has many advantages. The disclosed orthopedic post pad prevents damage to the pudendal nerve and its three branches. The inner cushion layer of the post is configured to line up and abut with the ischial tuberosities. The outer cushion layer comprises an additional cushion volume to prevent the male's genitals from falling into the gap that would otherwise be left by the lune shape of the inner cushion layer. The inner cushion layer and outer cushion layer may be of different colors from each other to indicate to the users that the cushion layers are of different density and/or cushioning. The location of the post pad hole away from (distal to) the center of the pad, and on a side opposite of the patient provides more cushioning for the patient.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. An orthopedic post pad comprising:
an inner cushion layer, the inner cushion layer having a first peak, and a second peak, with a volume removed from the inner cushion layer between the two peaks along a height of the inner cushion layer, and the inner cushion layer comprising an inner lateral surface, and a concave surface, where the concave surface abuts the volume removed from the inner cushion layer;
a post hole located in the inner cushion layer on a side opposite the two peaks;
an outer cushion layer enveloping the inner lateral surface and concave surface of the inner cushion, the outer cushion layer and inner cushion layer together generally forming a right cylindrical shape.

2. The orthopedic post pad of claim 1, wherein the inner cushion layer has a lune shape.

3. The orthopedic pad of claim 1, wherein the outer cushion layer is made from an ultra-soft foam.

4. The orthopedic pad of claim 1, wherein the inner cushion layer is made from a foam cushioning that is resistant to over 100 pounds of pressure.

5. The orthopedic pad of claim 1, wherein the post pad hole is not located at the center of the orthopedic pad.

6. The orthopedic pad of claim 5, wherein the post pad hole is located about 1.9″ away from the center of the orthopedic pad, measured along a diameter of the post pad.

7. The orthopedic pad of claim 1, where the orthopedic pad has a height H of about 8″ to about 9.5″, an outer diameter of about 7.25″ to about 9.5″, and the distance between the first peak and the second peak are about 4″ to about 7″.

8. The orthopedic pad of claim 1, where the orthopedic pad has a height H of about 9″, an outer diameter of about 9″, and the distance between the first peak and the second peak of about 5.75″.

9. The orthopedic pad of claim 1, where the orthopedic pad has a height H of about 9″, an outer diameter of about 7′ to about 7.5″, and the distance between the first peak and the second peak of about 4.5″ to about 5″.

10. The orthopedic pad of claim 1, wherein the post hole has a diameter of about 0.75″ to 2″.

11. The orthopedic pad of claim 1, wherein the post hole has a diameter of about 1.25″.

12. The orthopedic pad of claim 1, wherein the outer cushion layer is a different color from the inner cushion layer.
